(19) United States
(12) Patent Application Publication
(10) Pub. No.: US 2006/0169797 A1
(43) Pub. Date: Aug. 3, 2006

(54) Non-pneumatic motor vehicle wheel and methods for using the same

(76) Inventor: Steven R. Kaltenheuser, Ames, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/342,483

(22) Filed: Jan. 30, 2006

Related U.S. Application Data
(60) Provisional application No. 60/648,851, filed on Jan. 31, 2005.

(51) Int. Cl. B05B 9/00

(52) U.S. Cl. 239/147; 152/209.12

(57) ABSTRACT

An apparatus, method, and system of varying aspects. One aspect comprises a wheel having a rim with a perimeter and a plurality of non-pneumatic ground contacting members spaced apart on the perimeter. In another aspect of the invention, the wheel of that type is utilized to raise the ground clearance of a tractor. One application of raised ground clearance is for travel through a field of growing plants without substantial damage to the plants. One application is spraying during growing season with a conventional tractor instead of requiring a high clearance dedicated spraying rig or aerial spraying.

### CROSS-REFERENCE TO RELATED APPLICATIONS

This application claims priority under 35 U.S.C. § 119 of Provisional Application Ser. No. 60/648,851 filed Jan. 31, 2005, which application is hereby incorporated by reference in its entirety.

### INCORPORATION BY REFERENCE

The contents of U.S. Pat. No. 5,390,985 is incorporated by reference herein in its entirety.

### BACKGROUND OF THE INVENTION

A. Field of the Invention

The present invention relates to an apparatus, method, and system of a non-pneumatic motor vehicle wheel and, in particular, one that has the capability of both off road and over the road travel. One aspect of the invention relates to methods of use related to the wheel including spraying crops, and in particular, to an efficient and economical apparatus, method, and system providing relatively high clearance and high capacity but using relatively economical equipment.

B. Problems in the Art

Automotive wheels and tires have evolved dramatically. Early motor vehicles essentially borrowed horse-drawn carriage or wagon wheels made of wood with spokes. They later evolved to metal or steel wheels with relatively small pneumatic perimeters. More recently, tremendous resources have been directed towards advancing pneumatic tires. They provide certain advantages regarding ride, force absorption, and safety. Even in agricultural uses, pneumatic tires tend to be preferred, even on larger tractors. One exception is track-based automotive vehicles.

As tractors get larger, tires tend to get larger. Wheels or rims also tend to get bigger.

As is obvious, a pneumatic tire needs a reliable seal against the rim to retain its pneumatic pressure. Therefore, rims for pneumatic tires have certain profiles that are relatively complex to manufacture. They cannot simply be created from commodity materials or with complex techniques and tools.

Likewise, track-based vehicles are relatively complex. Tracks cannot be made by relatively non-complex methods or tools.

There have been attempts to make non-pneumatic or semi-pneumatic round wheels. For example, U.S. Pat. No. 5,390,985, incorporated by reference herein, discloses a “non-pneumatic, ground-engaging cushioning means with raised treads for tires or endless tracks”. A ground engaging segment 11 is bolted to a rim. Succeeding segments are bolted in close proximity to one another around the perimeter of the rim. U.S. Pat. No. 5,390,985 states “[t]he segments are mounted circumferentially on the rim with neighboring longitudinal faces confronting one another.” Column 3, lines 53-55. It continues, stating, “Thus mounted, on a rim or base, the segments cooperate to provide a tire body which is resiliently deformable under load. As the segments deform, raised tread portion 25 moves radially inwardly, so that ground engaging loads are directed laterally of the ventilation cavity 16 to confronting longitudinal faces 21, 22 which can pass these loads to neighboring elements.” Column 3, line 66 to column 4, line 4.

U.S. Pat. No. 5,478,141 shows a different type of ground engaging element. Adjacent ground engaging elements are in abutment.

The invention was developed in response to and is applicable to solving the following problem. Asian rust disease is rapidly advancing into the United States regarding soybeans. A very short window of time is available to spray the soybeans to attempt to control the disease once it is identified on or near the plants. If such a disease is ignored, crop yield can suffer—in fact, it can essentially destroy crop yield (could destroy 80% or so of the yield within 11 days of reaching the crops).

For example, it is estimated that a farmer has but three days to spray if Asian rust disease is identified within 300 miles of the farmer's fields. If the disease is identified closer, it could be a matter of just a couple of days or less.

Because of the short time window, many times spraying must occur even if field conditions would otherwise cause a farmer to wait. For example, spraying must be done even if it is raining and/or the fields are wet. If not time critical, the farmer might wait until drier conditions because equipment could get stuck or have difficulty with traction in wet conditions. However, there may be no choice if the crop is to be saved.

If the disease comes when plants are in early stages of development, early in the growing season, a variety of conventional spraying options exist. However, those options decrease if the spraying is needed later in the growing season (e.g. after July 1, in Iowa) because the soybean plants are approaching full height. This limits the type of equipment that can get into the field and spray without damaging the plants.

Presently two main options exist for spraying for soybean rust once the plants are to mid- or late-season in stage. Both have certain problems and deficiencies.

First, self-propelled high clearance spraying systems are commercially available. An example is model number 2101 sprayer of Hagie Manufacturing of Clarion, Iowa (USA). U.S. Pat. Nos. 6,386,554; 5,755,382; Des344,737 show other examples. They have the advantage of high clearance so that they can be run through a field of even half grown soybeans without breaking or bending the plants. Also, the systems are dedicated sprayers. It is their sole function. Therefore, they can be quite advanced. Disadvantages include substantially high costs. They can cost anywhere from around $200,000 and up. Also, they tend to have limitations on payload. For example, the amount of spraying fluid they can carry at one time is limited. This can require more frequent refilling, which is inefficient. Also, because they are dedicated, they have no other use. Therefore, when not needed for spraying, they sit idle. They must be stored or rented. Either way, it is substantially costly.

Secondly, aerial spraying is another choice. The farmer is not required to purchase any equipment. However, they still must purchase the spray and rely on the availability and accuracy of the pilot. This can create significant problems. There is not unlimited availability of crop spraying planes and pilots. With a disease like soybean rust, the available time for catching it is very limited. Therefore, to rely on a crop spraying plane may result in missing the usually short window of time and risk the detrimental effect that could follow. Also, aerial spraying may not be very effective. For example, on Asian soybean rust disease, it may not be very effective because payload limitations of an airplane limit the amount of water that can be carried and mixed with the active ingredients to combat the disease.

As can be appreciated, there is a need for a more economical system to allow farmers to spray for this disease, as well as other spraying applications. One example is side dressing corn with liquid nitrogen during mid- to late-season. Another is spraying to get rid of soybean aphids in mid- to late-season.

In experimentation with combinations such as U.S. Pat. No. 5,390,985 or 5,478,141, it was found that traction, especially in wet or muddy fields, was poor. As previously discussed, it can be critical that spraying be done in a timely fashion. This means spraying sometimes must be accomplished in wet or muddy fields. Therefore, the two above-mentioned patents has deficiencies. It is believed the poor traction is the result of the specific teaching of these patents that the ground contacting tread pieces be either in abutment or very close to abutment (so close that they come into abutment when deformed under load).

Therefore, a need has been identified for a more economical, non-complex, practical way of gaining sufficient ground clearance with existing multi-purpose farm equipment to overcome the above identified problem. With this endeavor, it can be appreciated that non-complex wheels, made from commodity type materials that can be formed by non-complex techniques and tools, are desirable. Therefore, economic issues, timing issues, and efficiency issues exist in the art. A need has also been identified with respect to such a wheel for other uses and applications.

### SUMMARY OF THE INVENTION

It is therefore a principle object of the present invention to solve or overcome the problems and deficiencies in the art. Further objects, features, and advantages of the present invention will become apparent with reference to the accompanying specification and claims.

In one aspect of the invention, a wheel comprises a rim made of commodity materials. A plurality of receivers or brackets are fixed at spaced apart positions around the perimeter of the rim. Lugs are mounted in the receivers or brackets. Treads are spaced from each other and contained in the brackets in a manner that does not allow them to abut one another, even under deformation. This leaves substantial gaps between the treads.

In another aspect of the invention, a wheel, as previously described, has a diameter taller than the conventional wheels of an agricultural tractor. Installing a set of wheels according to the previously mentioned aspect of the invention raises an axle of a conventional tractor. By selection of the diameter of the wheels, the tractor can be raised a sufficient height to be useful to address certain problems or function well for certain applications.

Another aspect of the invention pertains to addressing problems and needs in the art related to crop spraying. The basic idea is to solve the dilemma of either purchasing a high capital cost dedicated piece of equipment like the self-propelled sprayers (see examples as discussed above) or hiring and relying upon an aerial spraying contractor. A more efficient, economical solution is needed. Additionally, a more practical solution is needed. The main idea of this aspect of the present invention is to combine the following:

a) a conventional large capacity, trailer sprayer with sufficient clearance for growing crops, including for substantially mature crops;

b) a separate but conventional tractor with sufficient horse power and drive components to pull the substantial sized spraying trailer through the field, even in wet or muddy conditions;

c) raising the clearance of the conventional tractor by installing larger diameter wheels to convert the normal tractor to a relatively high clearance tractor so it can pass through.

A spraying trailer can many times have a larger capacity tank (e.g. 1600 to 2600 gal. tank) and perhaps a wider boom reach than self-propelled sprayers (e.g. 1200 gal. tank). Its cost can be substantially less than a self-propelled sprayer.

A rear wheel drive tractor, optionally with front wheel drive assist, is usually also substantially less costly than the self-propelled sprayer. Importantly, it also can be used for the multitude of other functions needed in an agricultural environment when not needed for pulling the sprayer. In another aspect of the invention, by simply switching the normal wheels of such a tractor to a larger diameter, will raise the tractor relative to the ground and gain extra clearance so that it can travel through a crop field, even crops that are in relatively advanced growth stages.

A further aspect of the invention is a primarily non-pneumatic wheel for automotive vehicles.

As described below, there are a variety of ways to accomplish this.

It can therefore be seen that there are various aspects, features, embodiments, and features of the present invention. Further aspects, alternatives, embodiments, features and aspects of the invention will become more apparent with reference to the accompanying specification and claims.

### BRIEF DESCRIPTION OF THE DRAWINGS

FIG. 1 is a perspective view of one embodiment of the present invention installed on the rear axle of a rear wheel drive tractor with front drive assist.

FIG. 2 is an enlarged partial exploded view of a partially assembled wheel of the embodiment of FIG. 1.

FIG. 3 is an enlarged, isolated perspective view of a lug bracket from the embodiment of FIG. 1.

FIG. 4 is a reduced-in-size side elevation of the wheel of FIG. 1.

FIG. 5 is an alternative version of the wheel of FIG. 1.

FIG. 6 is a simplified diagram of a conventional commercially-available self-propelled, high clearance, prior art type crop sprayer.

FIG. 7 is a simplified diagram of a conventional commercially-available pull-behind sprayer trailer of the type that has relatively high clearance.

FIG. 8 is a simplified diagram of a conventional commercially-available rear wheel drive tractor with front wheel drive assist, such as are commercially available.

FIG. 9 is a simplified diagram illustrating the self-propelled sprayer of FIG. 6 moving through a field of substantially developed crop having a height indicated by the line “H”, and diagrammatically illustrating the clearance of the sprayer at line “C”; showing how the lowest clearance of the sprayer “C” exceeds the crop height “H”, allowing the sprayer to operate in the field without material damage to the crop.

FIG. 10 is a diagram comparing, on the left side, a conventional tractor such as shown in FIG. 8 pulling a conventional sprayer trailer 5 such a shown in FIG. 7, with, on the right side, a modified tractor with larger diameter front and rear tires (according to one aspect of the invention) pulling conventional sprayer trailer 5. Reference lines indicate the difference between crop height and tractor clearance for each system. The lowest clearance “C” of the system on the left (which is the drive components of the tractor) is lower than the crop height “H”. The lowest clearance “C” of the system on the right (the tractor modified according to one aspect of the present invention) is near or above the crop height “H”.

FIG. 11 is a diagram showing a conventional rear tire for a conventional tractor of FIGS. 1 and 8 on the left, with two alternative replacement rear tires (center and right) according to different aspects of the present invention.

FIG. 12 are front elevational views of the three tires of FIG. 11.

### DETAILED DESCRIPTION OF THE PREFERRED EMBODIMENT

A. Overview

For a better understanding of the invention, one example of how it could be built and utilized will now be described in detail. Alternatives and optional features will also be described.

This example is in the context of a spraying system that can be used to spray soybeans during mid- to late-season when the soybean plants are substantially developed (even to close to full height). One example of the need for such spraying is to fend off Asian soybean rust disease.

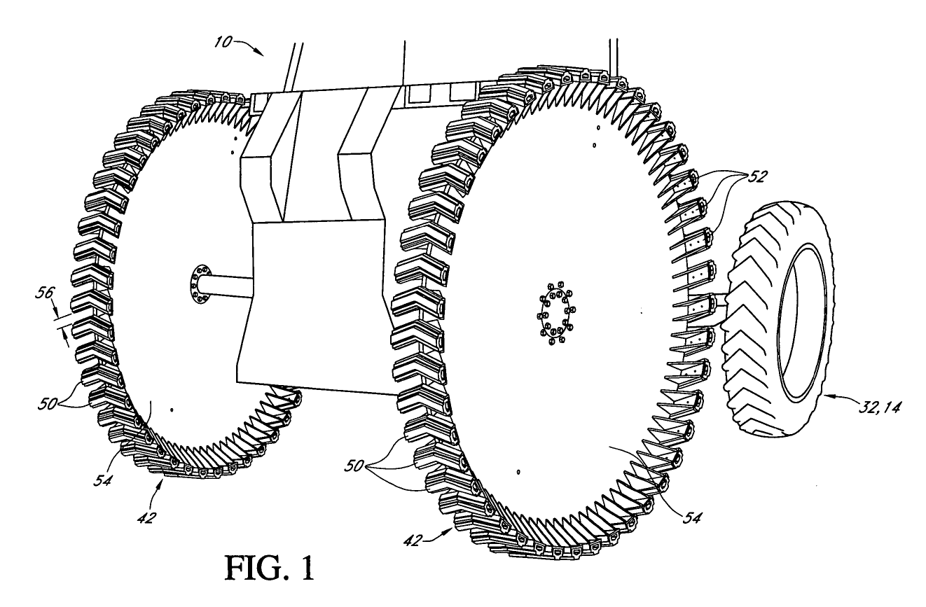

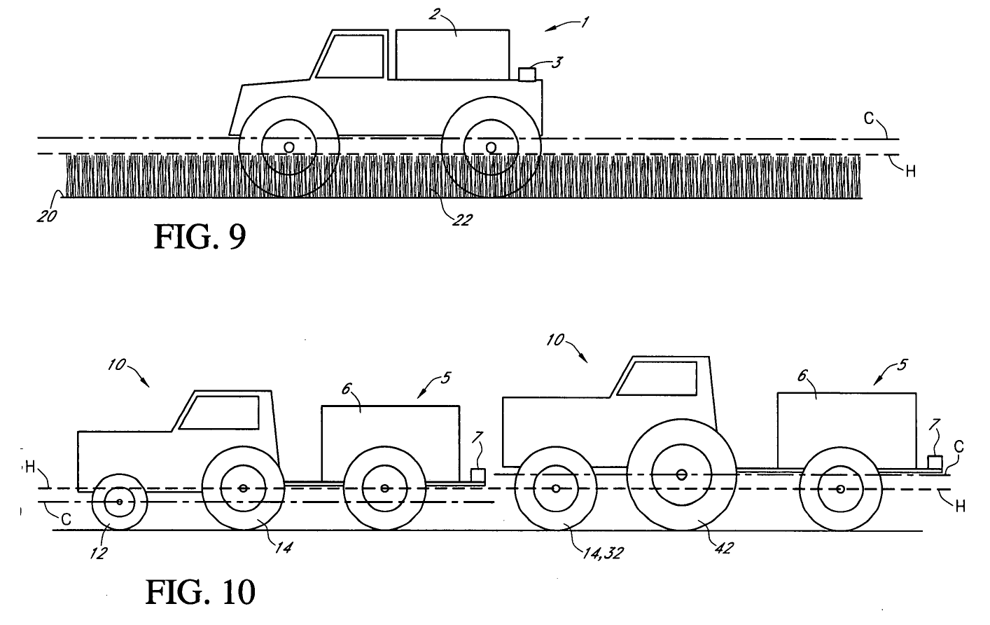

As illustrated on the right side of FIG. 1, one exemplary embodiment of the invention includes a rear wheel drive, front wheel drive assist tractor 10 (e.g. John Deere 7020 or 6020 series tractors) attached to and pulling a conventional relatively large sprayer trailer 5 (for example, Best Way Field Pro II, RHS, Inc. of Hiawatha, Kans. (USA); or Spray-Caddie and 4200 precision crop sprayers, of Progressive Farm Products, Inc., Hudson, Ill., (USA)). Tractor 10 has been modified, however, by replacing its normal front four foot diameter and rear six foot diameter pneumatic tires, with larger six feet diameter front and eight foot diameter rear pneumatic tires, respectively, on conventional steel rims. This raises the clearance of tractor 10 above the height “H” (see FIGS. 9 and 10) for soybeans at mid- to late-season. Instead of the axle height of the front tires being around two feet or 24 inches (one-half of the four feet tire diameter), it is raised approximately one foot to around three feet or 36 inches (one-half the new six foot tire diameter). Since soybeans at mid- to late-season tend to exceed 24 inches in height “H”, this modification would clear the tractor to move through a soybean field without substantial or material damage to the plants. On the other hand, a tractor clearance of only 24 inches would likely strike and damage an appreciable number of plants.

As illustrated in FIG. 10, conventional trailer 5 is selected to have a crop clearance sufficient to substantially clear mid- to late-season soybeans. As indicated in FIG. 10, therefore, by the mere modification of just tractor 10 clearance, a conventional tractor and spraying trailer could be used (as indicated by the right-side tractor and trailer in FIG. 10). Without such modification, tractor clearance would be well under what is considered appropriate to travel in a field of mid- to late-season soybeans (see left-side tractor in FIG. 10). No adjustment to trailer 5 may be necessary. The trailer would be adjusted or inherently have a clearance above crop height.

In the illustration of FIG. 10, the standard tractor 10 on the left has four foot outside diameter front wheels 12 and six foot outside diameter rear wheels 14. For tractor 10 on the right, the diameter has been increased two feet for each wheel (to six foot outside diameter front wheels 32 or 42 and eight foot outside diameter rear wheels 34 or 44). This raises the clearance of the tractor approximately one foot. This should raise it up to a clearance of 30 to 36 inches for most tractors 10, which should be sufficient for mid- to late-season soybeans. Also, the essential nature of tractor 10 is retained. It could be unhooked from trailer 5 and be available for other uses. It could be separated quickly and easily from trailer 5 and moved or used to pull other things, and then re-hooked to continue spraying. It can travel in most ground conditions, including fields (wet or dry) or payment or gravel.

It is to be understood that one other factor is involved. Increasing the size of both front and back wheels of tractor 10 allows the gear train for both the rear wheel drive and the front wheel drive assist to operate without substantial adverse affect. If only the rear or the front wheels were increased in size, it could substantially mismatch the designed interaction of the gear train. This could make it risky to operate the front wheel drive assist, because it could put stress and strain on the drive train. This is similar to the damage that could be caused if larger or smaller than designed diameter tires are mounted on the front or back of an all-wheel drive vehicle. The larger wheels would turn slower than the smaller wheels. This could cause wear or even more severe damage to the gearing, which is designed for the same diameter tires at all four wheels. For example, one type of tractor 10 has a 1:1.33 ratio between rear and front tires. If the size of just front or rear tires were changed substantially, it would throw off the pre-designed gearing ratios and could damage the drive train, especially if the front wheel drive assist was operated continuously, as would likely be needed in muddy fields or pulling large capacity sprayer trailers.

This can be a real issue, especially in difficult conditions (such as muddy fields). If one set of wheels were mismatched from the design of the drive system, they might turn faster or slower than the other set. This could substantially reduce traction of the vehicle, as well as damage the drive train or associated parts. It could also cause mud to be thrown up, affecting driving and vision, as well as affecting plants. This should be taken into account for all-wheel drive or front assist drive vehicles.

B. Exemplary Wheels

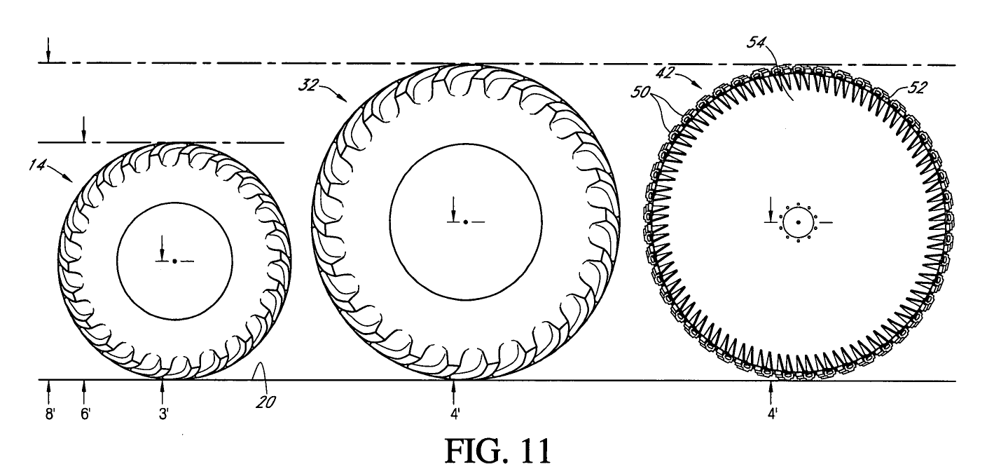

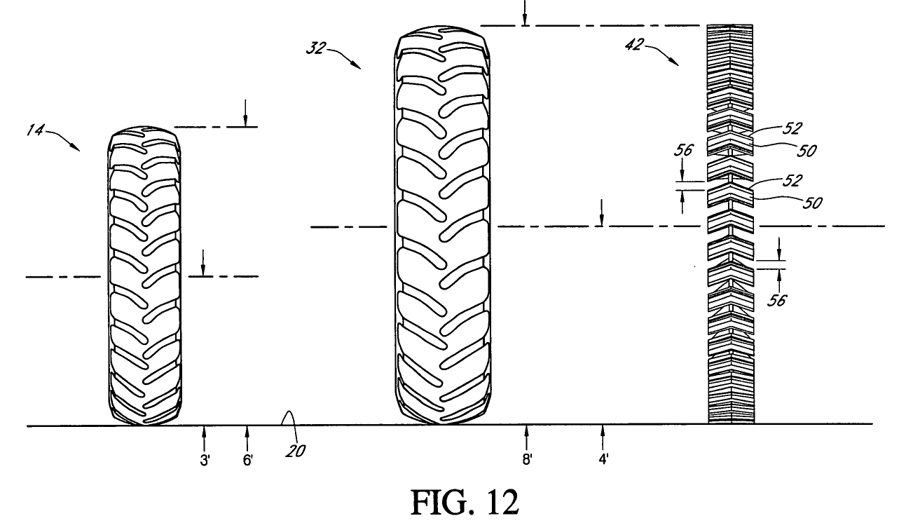

FIGS. 11 and 12 illustrate standard size rear wheels 14 for tractor 10 on the left and increased size rear wheels 32, 42 on the right. This is set forth to illustrate increased diameter rear wheels could take different forms and embodiments.

In one embodiment (the middle wheels 32 in FIGS. 11 and 12), a standard pneumatic rear tractor tire 32 is created with on the order of eight foot outer diameter (or somewhere on the order of 70 to 80 inches). This would replace the conventional six foot diameter rear tire 14 (the left most tire). However, presently, a rear pneumatic tractor tire of this diameter is not known to be commercially available. Therefore, an alternative large rear wheel 42, that can be fabricated by individual farmers or mass produced without the need for the technology of pneumatic tires, is shown in the right-most drawings in FIGS. 11 and 12. A one-inch thick plate steel wheel or plate 54 having an almost eight foot outside diameter has a plurality of rubber lugs 50 attached around its outside diameter (see FIGS. 1-5). This wheel 42 has the approximately eight foot outside diameter and would have the conventional lug configuration (e.g. 10-11 lug configuration) to mount on a standard rear hub of tractor 10, but would raise the rear of tractor 10 as previously described. Lugs 50 would allow it to gain traction, especially in field soil, including mud, as well as run for at least limited distances over the roads, including paved roads.

Thus, FIGS. 11 and 12 illustrate two alternative ways that normal tires for tractor 10 can be replaced with larger diameter tires or wheels to raise the rear of the tractor. Of course, front tires 12 of conventional tractor 10 could be substituted with a larger diameter tires either of the type of reference number 32 or 42. Again, in this example, conventional four foot diameter front tires 12 would be replaced with six foot tall tires of the type of either pneumatic tires 32 or steel rim with rubber outer lugs as in reference number 42.

Thus, the general concept is to add larger diameter tires or wheels to both front and rear of tractor 10 to raise its ground clearance and generally preserve the size ratio of front and rear wheels to deter damage to the drive train.

Note that it is possible, in this example, to transfer the conventional six foot diameter rear tires 14 from a conventional tractor 10 to the front of tractor 10 (to raise the front about one foot) and then add fabricated steel plate wheel 54 with lugs 50 (approx. eight foot diameter) to the rear of tractor 10. In this way, only two new wheels would be needed to raise tractor 10 (see FIG. 1). Alternatively, new six foot diameter steel plate wheels 54 (with lugs 50) could be added to the front and new eight foot diameter steel plate 54/lugs 50 wheels added to the back.

C. Specific Lug Configuration

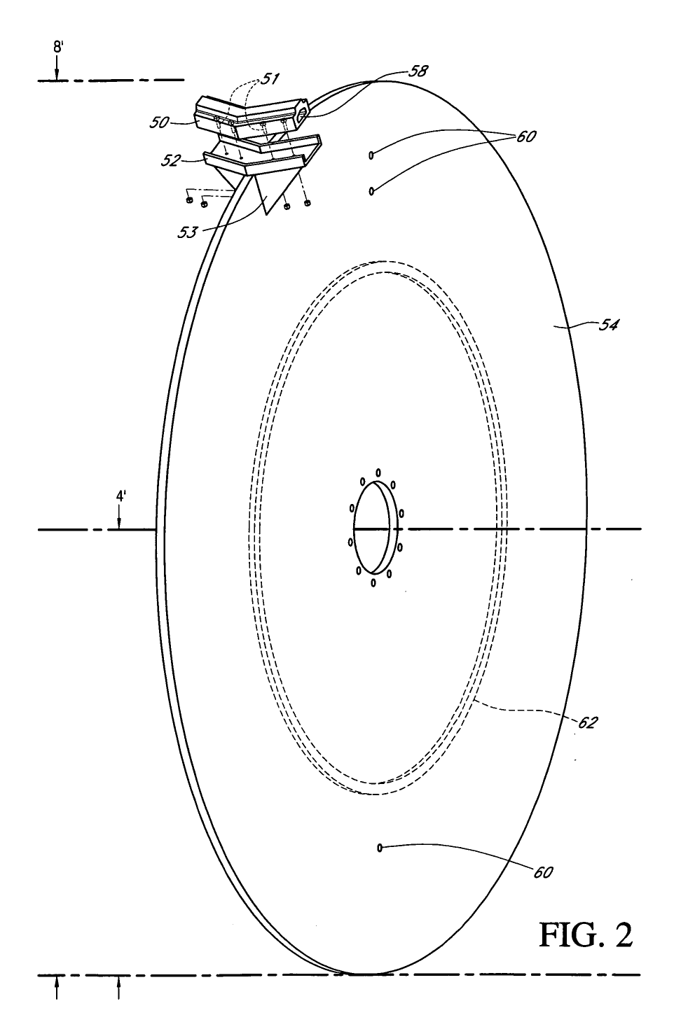

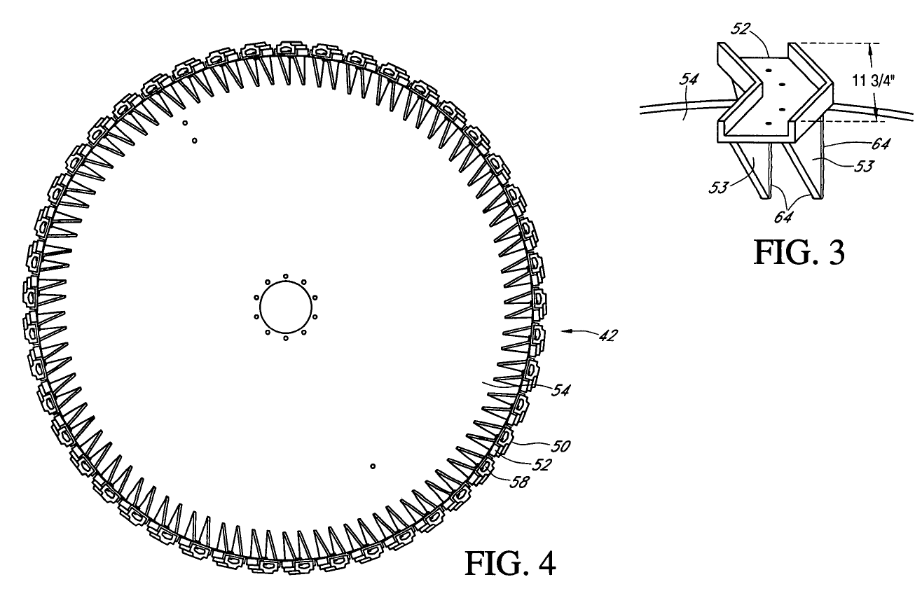

FIGS. 1 and 2 show more specific details about the right-most wheel 42 of FIGS. 11 and 12. There are forty-five lugs 50 bolted to U-shaped brackets 52 at spaced apart positions around the perimeter of the one inch thick steel plate wheel 54. Each lug is approximately 10 to 15 inches wide and 1⅜ inches front to back edge. There are approximately 3 inch spaces between the back and front edges of each adjacent lug 50. As can be seen in FIG. 1, lugs 50 are basically V-shaped. FIG. 2 shows the U-shaped-in-cross-section bracket 52 into which each V-shaped lug 50 fits (the top portion of each lug 50 extends outside of the bracket 52 somewhat). Captured bolts 51 in lug 50 extend out of its bottom surface and pass through holes in bracket 52 (see welds 64 in FIG. 3). Nuts secure lug 50 to bracket 52 from underneath. Note that triangular support flanges 53 extend from the bottom of each side of each bracket 52 inwardly. Flanges 53 are welded to bracket 52. Bracket 52 is welded to the edge of steel plate 54.

FIG. 2 shows a specific way of attaching one rubber lug 50 to steel wheel 54 (the other lugs 50 and brackets 52 are not shown for simplicity). Lugs 50 could be of the type available from AirBoss of America Corp. They could be bolted onto brackets or lug frames 52 that are in turn bolted onto the exterior of steel rim 54. Various ways of attaching the lugs can be seen at U.S. Pat. No. 5,390,985, which is incorporated by reference herein. In FIG. 2 only one lug and lug frame is shown for exemplary purposes. However, as indicated at FIGS. 1, 2, 4, 11 and 12, in one embodiment a plurality of lugs 50 could be spaced apart (and approximately three inches from adjacent lugs) all around rim 54. This will allow open spaces between the lugs which should help traction in mud. It will allow mud to self clean from between lugs 50 so that it will not pack in. This arrangement allows the mud to be channeled out and away from the wheel to reduce spinning and improve traction.

U.S. Pat. No. 5,390,985 illustrates that lugs 50 could be solid rubber except for an open channel 58 through it from side to side. This would provide at least some cushioning, especially when driven on hard surfaces. The lugs could, however, be solid rubber or other materials.

These lugs 50 are traditionally used on skid or front-end loaders. As shown in U.S. Pat. No. 5,390,985, for those uses they tend to be closely spaced, even in abutment with one another. It is believed abutment is needed for stability and to keep them attached to the wheel. However, with wheel 42 of FIGS. 1 and 2, the brackets or frames 52 hold the lugs intact and resist flexing or bending. This allows the three inch gap between lugs 50 in the exemplary embodiment.

Use of wheels 42 (with steel plate 54 and lugs 50) on just the rear of tractor 10 would add cost to the spraying system. However, cost of the system, including conventional tractor 10 and conventional sprayer trailer 5, would still not even approach the cost of the self-propelled sprayer of FIGS. 6 and 9. Additionally, tractor 10, even with the two or four new wheels, could have other uses or could be quickly converted back to original form by putting back the original tires.

Note in FIGS. 1 and 2 a center opening in plate 54 can receive the standard rear hub of tractor 10. A conventional 10 lug bolt pattern can be formed in plate 54. Also, as seen in FIGS. 1 and 2, several lifting holes 60 could be formed in plate 54 to assist in handling of the wheel to put in on or take it off tractor 10.

Also, the dashed circle 62 on the side of steel plate 54 in FIG. 2 is intended to show an optional add-on. It is believed that welding a steel band or ring (e.g. several inches wide) along the side of steel plate 54 (the band would have a diameter less than the diameter of plate 54) would deter wobbling of plate 54. It would add structural strength and resistance to flexing.

D. Options and Alternatives

The foregoing provides just a few examples of the invention. The invention is not limited to these examples. Variations obvious to those skilled in the art are included within the invention.

For example, specific sizes and configurations can vary according to need. For example, lugs 50 could be wider (e.g. 15½″) transverse to the plane of plate 54 and/or wider in the plane of plate 54. Lug frame 52 just has to be sized accordingly. Normally, a narrower lug is better for wet field conditions. The diameter of the tires could be designed for increased clearance for different clearances up to reasonable levels.

Another example would be replacement wheels could be put on other types of tractors including quad four wheel drive tractors that have equal diameter tires on all four tires. The invention would contemplate raising the clearance of such a tractor by adding the same larger diameter tires to each of the four wheels.

Additionally, the invention could have other uses. For example, wheels 42 could be used on other automotive vehicles, including trucks or cars. Several others are mentioned herein. Still others are possible. There could be other necessitated increased ground clearance uses for a tractor, whether for spraying or for other uses.

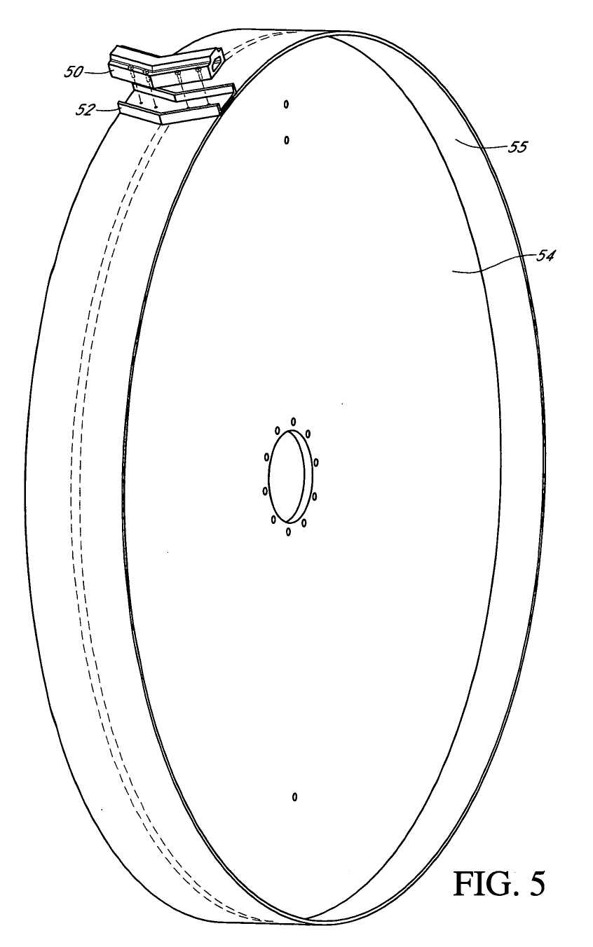

FIG. 5 shows an alternative way to build a steel wheel with lugs 50. Instead of welding brackets 52 to a one inch wide edge of steel plate 54 (as in FIGS. 1 and 2), in FIG. 5 a steel band 55 (e.g. ⅜ to ½ inch thick and 5 inches wide) would be welded to the outside of steel plate 54 (centered on its one inch wide edge). Brackets 52 would then be welded to the outer face of the steel band. This would eliminate the need for the triangular support braces 53.

As can be appreciated from the foregoing, one aspect of the invention was the result of trying to solve the soybean rust spraying problem. Non-pneumatic wheels according to the present invention of sufficient size could be manufactured using commercially available raw materials (e.g. 1″ steel plate) and using common shop tools and techniques (e.g. welding, drilling, bolting). Sophisticated, complex-shaped rims, not capable of home shop manufacture from commodity raw materials, are not required. The invention results in a rather economical and practical solution. It is furthered by the ability to utilize a multi-task tractor for this very specific task. Switch-over to regular pneumatic wheels is straight forward and relatively easy. Other spraying applications are, of course, possible (e.g. 51″ corn).

It should further be understood, however, that the basic configuration of the wheel according to one aspect of the invention, provides a different type of wheel than the state-of-the-art. As mentioned, the prior art utilizes non-pneumatic rubber-type lugs bolted to receivers on a rim to create a wheel, including a wheel for a tractor. However, they use complex rims as opposed to rims of commercially available, common, raw materials. They also rely on placement of the lugs so that they can deform against each other in the plane of the wheel. They specifically want the lugs to come into abutment with one another to transmit forces around the entire set of lugs, instead of having each lug handle it individually. Note that different types of lugs 50 could be used. It is possible that semi-pneumatic or even pneumatic lugs could be used. Tread could be added. Different types of material could be used (e.g. softer rubber for better ride on roads). Note also that a metal strip nut or washer could be used with the bolts and nuts used to mount each lug 50 to its lug frame 52 (e.g., between bolt head and lug or lug bracket, or between nut and lug or lug bracket).

As set forth in the exemplary embodiment of the wheel according to the present invention, the receivers are spaced apart. Also the receivers have radial walls that tend to not allow the lug to deform towards neighboring lugs. This teaches away from the state-of-the-art such as the patents described above. It has also been found that this spacing can actually assist in traction, especially wet and muddy fields.

Therefore, it is submitted that the basic aspects of the wheels alone differ from and represent improvement over some problems and deficiencies in the art.

For that reason, it is respectfully submitted an alternative embodiment of the invention relates to simply using a wheel on virtually any motor vehicle for taking advantage of the benefits described herein. The invention is not necessarily limited to agricultural tractors or spraying applications.

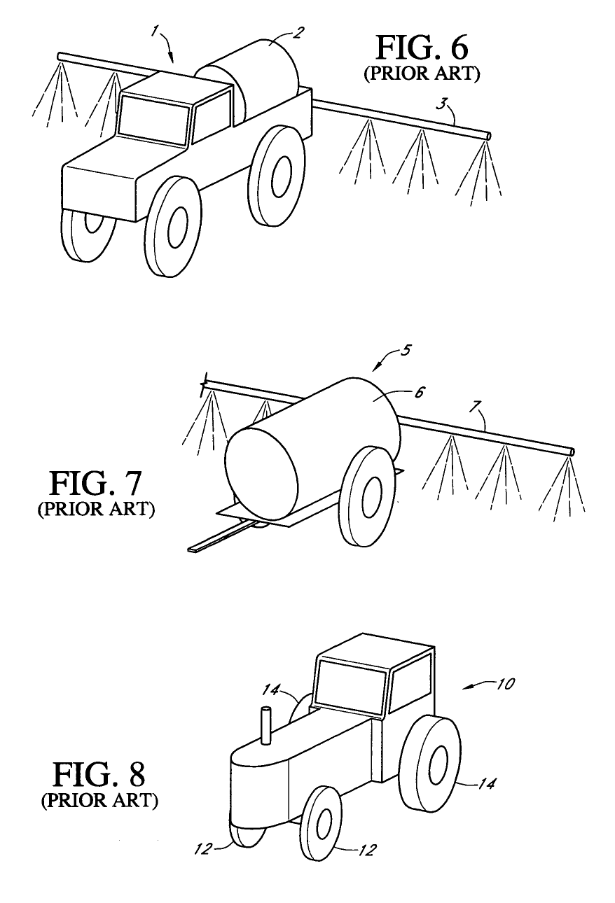

A further alternative for one aspect of the invention is use of a wheel like that shown in FIGS. 1-4 on a non-motorized vehicle. An example would be on a trailer. A specific example of a trailer would be a sprayer trailer such as shown in FIGS. 7 and 10.

What is claimed is:

1. A method of economical efficient crop spraying, comprising:
a. raising the operating clearance of a conventional tractor;
b. pulling a conventional large capacity sprayer trailer with the raised ground clearance tractor.

2. An apparatus for efficient economical spraying, comprising:
a. a conventional tractor;
b. a large capacity sprayer trailer;
c. replacement wheels that increase the ground clearance of the conventional tractor.

3. The apparatus of claim 2 wherein the replacement wheels comprise a steel wheel having rubber lugs spaced around its perimeter.

4. The apparatus of claim 3 wherein the lugs are bolted to the exterior of the steel wheel on V-shaped flanges on the perimeter of the wheel.

5. The apparatus of claim 3 wherein the rubber lugs have a hollow interior portion.

6. A vehicle wheel comprising:
a. a rim having a perimeter;
b. a plurality of ground engaging members spread apart around the perimeter of the rim so that they do not touch confronting faces when deformed in normal operation.

7. The wheel of claim 6 further comprising receivers for the ground contacting members fixed around the perimeter of the wheel.

8. The wheel of claim 7 wherein the receiver comprises a C-shaped channel member.

9. The wheel of claim 6 wherein the rim comprises a steel plate.

10. The wheel of claim 9 further comprising a ring of steel plate around the perimeter of the rim.

11. The wheel of claim 6 in combination with an automotive vehicle.

12. The combination of claim 11 wherein the automotive vehicle is a tractor.

13. The combination of claim 12 wherein the tractor is rear wheel drive with front wheel assist.

14. The combination of claim 11 in further combination with a sprayer trailer adapted to be pulled by the automotive vehicle.

15. The combination of claim 14 wherein the sprayer trailer has at least one set of wheels that raise the bottom of the trailer to at or higher than the ground clearance of the automotive vehicle.

16. The combination of claim 14 wherein the sprayer trailer comprises a relatively large capacity spray tank.

17. The combination of claim 16 wherein the relatively large capacity spray tank has a capacity of hundreds or more gallons of liquid.

18. A vehicle wheel comprising:
a. a steel plate having a round perimeter edge;
b. ground contacting members mounted in spaced apart positions around the perimeter edge.

19. The wheel of claim 18 wherein the ground perimeter members are non-pneumatic rubber type hollow members.

20. A method for higher ground clearance for a tractor comprising:
a. removing the normal rear wheel drive pneumatic tires from the tractor and substituting wheels of larger diameter, the wheels comprising a rim with a perimeter, a plurality of ground contacting members spaced around the perimeter in a manner that they do not touch confronting faces when deformed.

21. The method of claim 20 further comprising removing the front assist pneumatic wheels from the tractor and substituting the rear pneumatic wheels.

22. The method of claim 21 wherein the diameter of the tire wheels is selected to approximately raise the ground clearance of the rear of the tractor the same amount as the front ground clearance is raised when substituting the rear pneumatic wheels for the normal pneumatic wheels.

23. The method of claim 20 further comprising using the tractor to run through a field without a sufficient breaking or damaging growing plants.

24. The method of claim 23 wherein the tractor pulls a spraying rig carrying a full tank of relatively large capacity.
